(19) United States
(12) Patent Application Publication
(10) Pub. No.: US 2022/0065116 A1
(43) Pub. Date: Mar. 3, 2022

(54) WOUND RETAINING WIRE

(71) Applicant: Raytheon Technologies Corporation, Farmington, CT (US)

(72) Inventors: Armando Amador, Wethersfield, CT (US); Andrew V. Schwendenmann, Hampden, MA (US)

(21) Appl. No.: 17/003,438

(22) Filed: Aug. 26, 2020

(51) Int. Cl. F01D 5/30; F01D 1/02; F01D 11/00

(52) U.S. Cl. CPC F01D 5/3007; F01D 1/02; F05D 2260/30; F05D 2230/60; F01D 11/001

(57) ABSTRACT

An assembly of a gas turbine engine includes a first component, a second component disposed radially outboard of the first component. The second component includes one or more flange segments circumferentially spaced apart by one or more flange openings. Each flange segment includes a groove extending radially outwardly from a radially inboard surface of each flange segment between the first component and the second component. A retaining wire extends along each groove and is located radially between the first component and the second component to axially retain the second component to the first component. A radial cross-sectional size of the retaining wire is greater than a radial gap between the radially inboard surface of the second component and the first component.

### BACKGROUND

Exemplary embodiments of the present disclosure pertain to the art of seal arrangements for gas turbine engines, and in particular to retention of seal components of a gas turbine engine.

Retaining wires are a simple device, typically used for axially retaining components within a sub-assembly, such as a face seal. Retaining wires typically reside in a close-fitting groove that is designed to maintain the position of the wire within the assembly.

Typical retaining wires can take upon a variety of cross-sectional profiles. Typically, retaining wires are bent into a circular shape and have a split with a gap that extends radially. The gap allows them to collapse and twist in a spiral. These cross-sectional profiles may include circular or square shapes but are not limited to these.

The installation of retaining wire in the current state involves collapsing the ring and placing it under the intended groove. It is then allowed to expand and seat in the groove utilizing the natural spring force that is, in part, based on the material and cross section of the wire. At this point the wire is said to be seated and positioned.

### BRIEF DESCRIPTION

In one embodiment, an assembly of a gas turbine engine includes a first component, a second component disposed radially outboard of the first component. The second component includes one or more flange segments circumferentially spaced apart by one or more flange openings. Each flange segment includes a groove extending radially outwardly from a radially inboard surface of each flange segment between the first component and the second component. A retaining wire extends along each groove and is located radially between the first component and the second component to axially retain the second component to the first component. A radial cross-sectional size of the retaining wire is greater than a radial gap between the radially inboard surface of the second component and the first component.

Additionally or alternatively, in this or other embodiments the retaining wire is configured for installation via a flange opening of the one or more flange openings.

Additionally or alternatively, in this or other embodiments the retaining wire includes a removal feature.

Additionally or alternatively, in this or other embodiments the removal feature is a loop portion formed in the retaining wire.

Additionally or alternatively, in this or other embodiments both of a first wire end of the retaining wire and a second wire end of the retaining wire are installed into the groove.

Additionally or alternatively, in this or other embodiments the retaining wire is formed from one of metallic strip stock or sheet stock.

Additionally or alternatively, in this or other embodiments the retaining wire has one of a circular or rectangular cross-sectional shape.

In another embodiment, a face seal assembly of a gas turbine engine includes a seal element, a seal carrier in which the seal element is located, a seal shroud located radially outboard of the seal carrier, and a seal support located radially outboard of the seal shroud. The seal support includes one or more flange segments circumferentially spaced apart by one or more flange openings. Each flange segment includes a groove extending radially outwardly from a radially inboard surface of each flange segment between the seal shroud and the seal support. A retaining wire extends along each groove and is located radially between the seal shroud and the seal support to axially retain the seal shroud to the seal support. A radial cross-sectional size of the retaining wire is greater than a radial gap between the radially inboard surface of the seal support and the seal shroud.

Additionally or alternatively, in this or other embodiments the retaining wire is configured for installation via a flange opening of the one or more flange openings.

Additionally or alternatively, in this or other embodiments the retaining wire includes a removal feature.

Additionally or alternatively, in this or other embodiments the removal feature is a loop portion formed in the retaining wire.

Additionally or alternatively, in this or other embodiments both of a first wire end of the retaining wire and a second wire end of the retaining wire are installed into the groove.

Additionally or alternatively, in this or other embodiments the retaining wire is formed from one of metallic strip stock or sheet stock.

Additionally or alternatively, in this or other embodiments the retaining wire has one of a circular or rectangular cross-sectional shape.

Additionally or alternatively, in this or other embodiments the seal carrier includes an axial stop, and the seal shroud includes a shroud lip. The shroud lip is located axially between the axial stop and the retaining wire.

Additionally or alternatively, in this or other embodiments a biasing element is located at the seal carrier and is configured to urge the seal element toward a sealing surface.

In yet another embodiment, a method of assembling two components includes positioning a first component radially inboard of a second component. The second component includes one or more flange segments circumferentially spaced apart by one or more flange openings. Each flange segment includes a groove extending radially outwardly from a radially inboard surface of each flange segment between the first component and the second component. A first end of a retaining wire is inserted into the groove via a first flange opening of the one or more flange openings. The retaining wire is urged through the groove of each flange segment until a second end of the retaining wire is located at the first flange opening. The first component is retained to the second component via the retaining wire installed in the groove.

Additionally or alternatively, in this or other embodiments the second end is inserted into the groove at a flange segment at an opposite end of the first flange opening at which the first end was inserted.

Additionally or alternatively, in this or other embodiments a removal feature is formed in a second wire end of the retaining wire.

Additionally or alternatively, in this or other embodiments the retaining wire is removed by pulling the removal feature.

### BRIEF DESCRIPTION OF THE DRAWINGS

The following descriptions should not be considered limiting in any way. With reference to the accompanying drawings, like elements are numbered alike:

FIG. 1 is a partial cross-sectional view of a gas turbine engine;

FIG. 2 is a cross-sectional view of an embodiment of a face seal assembly;

FIGS. 3-7 illustrate installation of a retaining wire into a face seal assembly; and

FIG. 8 illustrates removal of a retaining wire from a face seal assembly.

### DETAILED DESCRIPTION

A detailed description of one or more embodiments of the disclosed apparatus and method are presented herein by way of exemplification and not limitation with reference to the Figures.

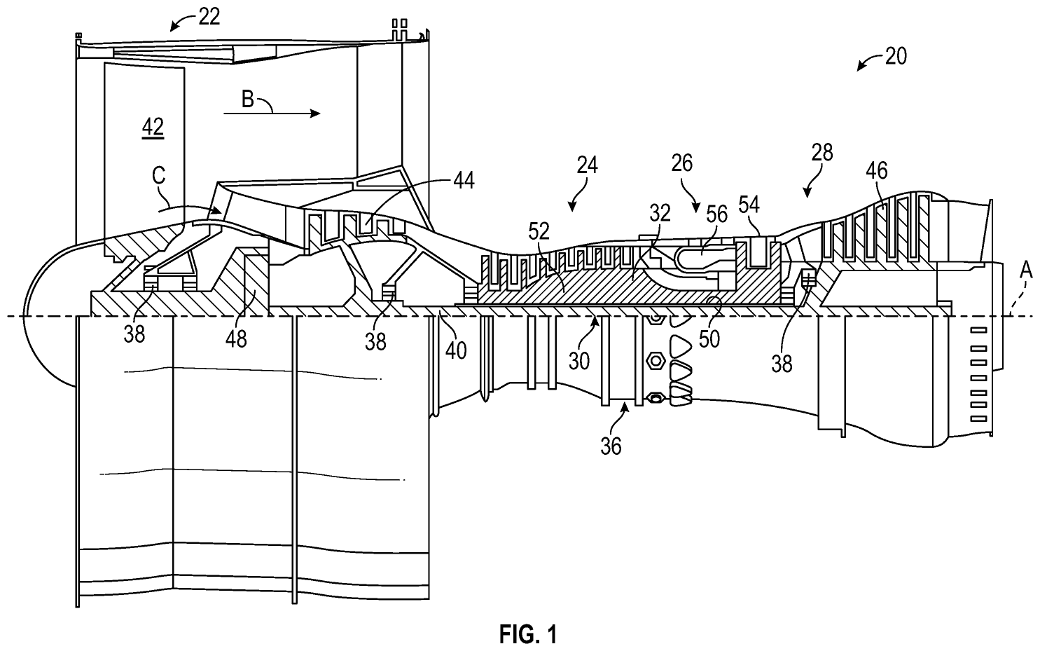

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include other systems or features. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present disclosure is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,688 meters). The flight condition of 0.8 Mach and 35,000 ft (10,688 meters), with the engine at its best fuel consumption—also known as “bucket cruise Thrust Specific Fuel Consumption (‘TSFC’)”—is the industry standard parameter of 1 bm of fuel being burned divided by 1 bf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram °R)/(518.7°R)]^{0.5}. The “Low corrected fan tip speed” as disclosed herein according to one non-limiting embodiment is less than about 1150 ft/second (350.5 m/sec).

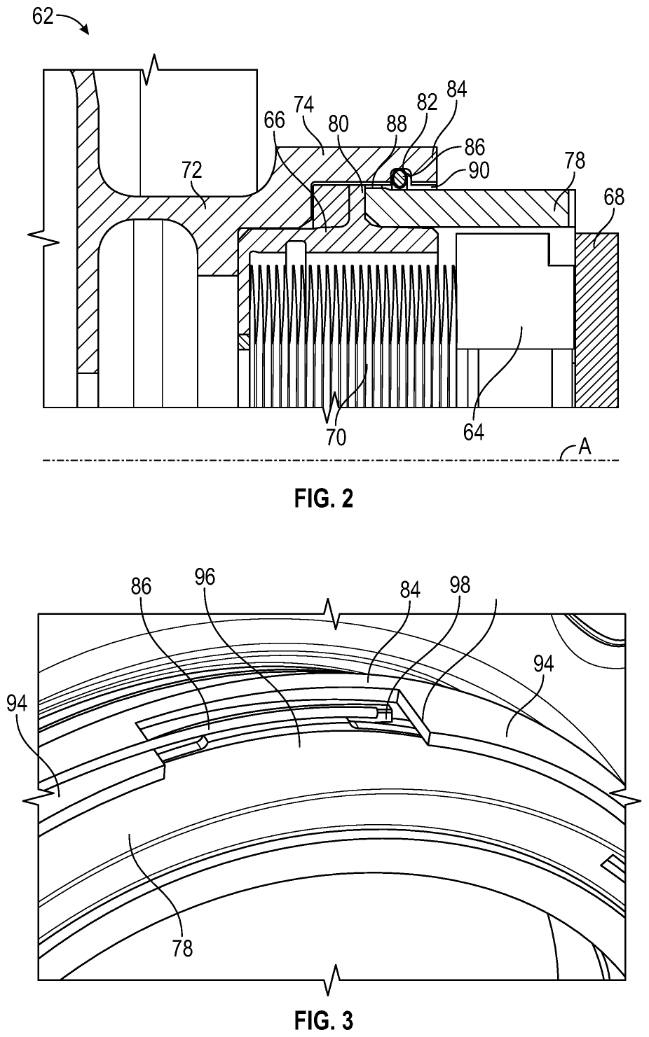

Referring now to FIG. 2, the gas turbine engine 20 includes one or more wire retentions located at, for example, bearing systems 38 or seal assemblies. One embodiment is illustrated in FIG. 2, and includes a face seal assembly 62. The face seal assembly 62 includes a seal element 64 disposed in a seal housing 66. The seal element 64 is configured to seal to a component, such as a flange 68 of a shaft or other rotating component. The seal element 64 is biased axially toward the flange 68 by, for example, a bellows spring 70 disposed in the seal housing 66. A seal support 72 includes a support flange 74, which is located radially outboard of the bellows spring 70, and which extends axially over the bellows spring 70 toward the seal element 64. A shroud 78 is located radially between the support flange 74 and the seal housing 66.

The seal housing 66 includes a housing flange 80, which limits how far the shroud 78 can be inserted between the seal housing 66 and the support flange 74. The support flange 74 includes a groove 82 extending circumferentially around a radially inner surface 84 of the support flange. A retaining wire 86 is installed into the groove 82 to reside between the support flange 74 and the shroud 78. In some embodiments, the retaining wire 86 is formed from, for example metallic strip or sheet stock. Further, while a circular cross-sectional retaining wire 86 is illustrated, other cross-sectional shapes such as rectangular or oval, for example, may be utilized. The shroud 78 includes a shroud lip 88 that, with the retaining wire 86 installed in the groove 82, is located between the retaining wire 86 and the support stop 80 so that the shroud 78 is axially retained by the support stop 80 and the retaining wire 86.

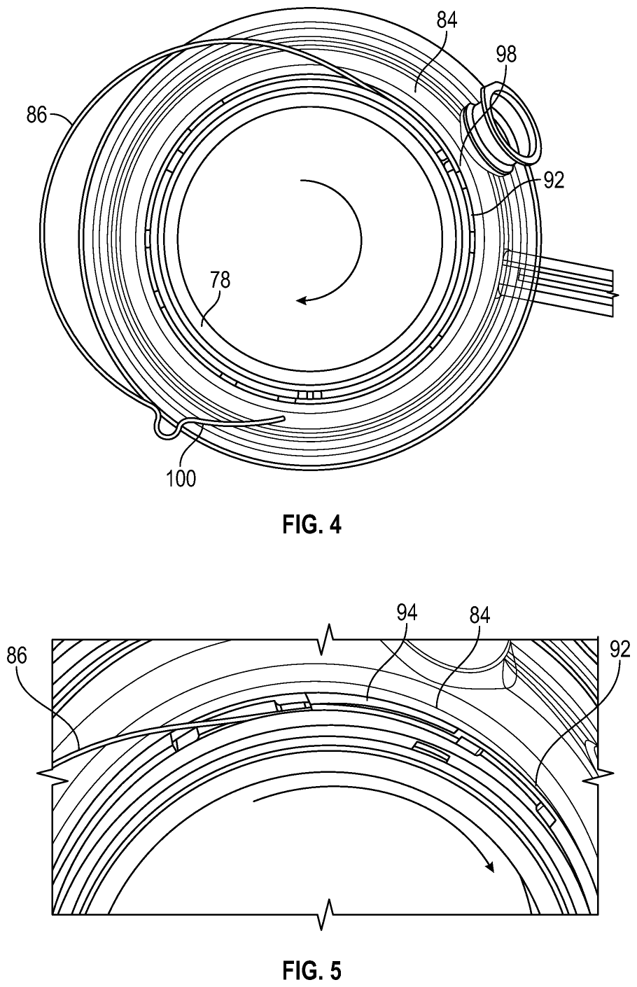

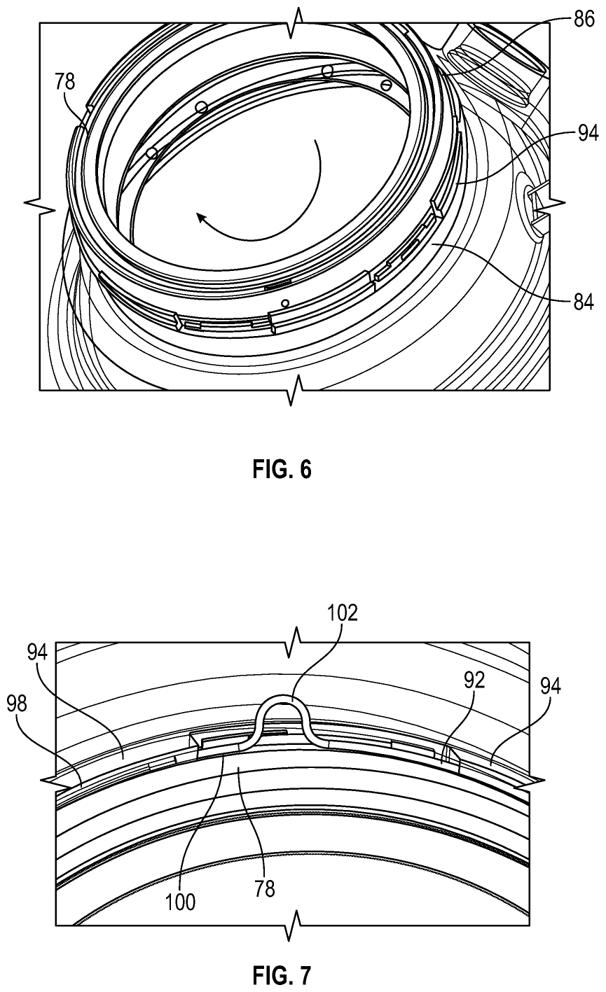

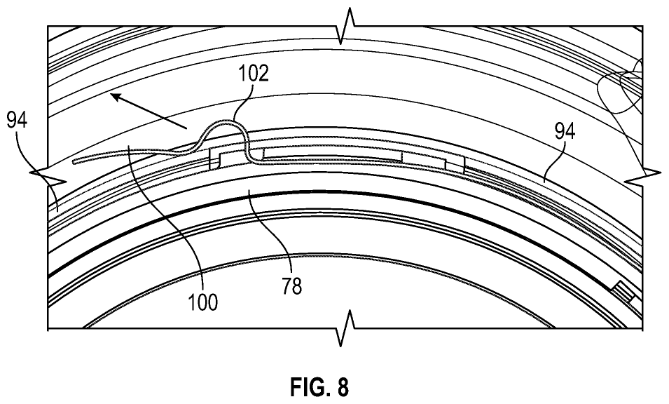

A radial gap 90 between the shroud 78 and the support flange 74 is smaller than a radial cross-sectional dimension of the retaining wire 86. The retaining wire 86 is thus installed circumferentially and not axially. Referring to FIG. 3, the support flange 74 is circumferentially segmented, and includes a singular or plurality of flange segments 94 circumferentially separated by flange openings 96. A first wire end 98 of the retaining wire 86 is installed into the groove 92, which is accessible via a first flange opening 96. Referring to FIGS. 4-6, the retaining wire 86 is urged circumferentially along the groove 92 until, as shown in FIG. 7, a second wire end 100 is located at the first flange opening 96. The second wire end 100 is inserted into a flange segment 94 at an opposite end of the first flange opening 96 to which the first wire end 98 was inserted. In some embodiments, the second wire end 100 includes a loop portion 102. The loop portion 102 allows for easy removal of the retaining wire 86 for disassembly of the face seal assembly 62 by pulling the loop portion 102 with, for example, a tool or hand, such as shown in FIG. 8. While a loop portion 102 is illustrated, it is to be appreciated that other removal features may be incorporated at the second wire end 100 to aid in removal of the retaining wire 86.

Utilizing the circumferentially-installed retaining wire 86 as described herein improves ease of installation of the retaining wire, and further improves ease or removal of the retaining wire for disassembly, while maintaining the close radial clearance between the mating parts to provide the desired degree of retention of the components. Additionally, the circumferential installation saves radial space since the wire is not required to be installed in the axial direction.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An assembly of a gas turbine engine, comprising:
a first component;
a second component disposed radially outboard of the first component, the second component including one or more flange segments circumferentially spaced apart by one or more flange openings, each flange segment including a groove extending radially outwardly from a radially inboard surface of each flange segment between the first component and the second component; and
a retaining wire extending along each groove and disposed radially between the first component and the second component to axially retain the second component to the first component;
wherein a radial cross-sectional size of the retaining wire is greater than a radial gap between the radially inboard surface of the second component and the first component.

2. The assembly of claim 1, wherein the retaining wire is configured for installation via a flange opening of the one or more flange openings.

3. The assembly of claim 1, wherein the retaining wire includes a removal feature.

4. The assembly of claim 3, wherein the removal feature is a loop portion formed in the retaining wire.

5. The assembly of claim 1, wherein both of a first wire end of the retaining wire and a second wire end of the retaining wire are installed into the groove.

6. The assembly of claim 1, wherein the retaining wire is formed from one of metallic strip stock or sheet stock.

7. The assembly of claim 1, wherein the retaining wire has one of a circular or rectangular cross-sectional shape.

8. A face seal assembly of a gas turbine engine, comprising:
a seal element;
a seal carrier in which the seal element is disposed;
a seal shroud disposed radially outboard of the seal carrier;
a seal support disposed radially outboard of the seal shroud, the seal support including one or more flange segments circumferentially spaced apart by one or more flange openings, each flange segment including a groove extending radially outwardly from a radially inboard surface of each flange segment between the seal shroud and the seal support; and
a retaining wire extending along each groove and disposed radially between the seal shroud and the seal support to axially retain the seal shroud to the seal support;
wherein a radial cross-sectional size of the retaining wire is greater than a radial gap between the radially inboard surface of the seal support and the seal shroud.

9. The face seal assembly of claim 9, wherein the retaining wire is configured for installation via a flange opening of the one or more flange openings.

10. The face seal assembly of claim 9, wherein the retaining wire includes a removal feature.

11. The face seal assembly of claim 10, wherein the removal feature is a loop portion formed in the retaining wire.

12. The face seal assembly of claim 9, wherein both of a first wire end of the retaining wire and a second wire end of the retaining wire are installed into the groove.

13. The face seal assembly of claim 9, wherein the retaining wire is formed from one of metallic strip stock or sheet stock.

14. The face seal assembly of claim 9, wherein the retaining wire has one of a circular or rectangular cross-sectional shape.

15. The face seal assembly of claim 9, wherein:
the seal carrier includes an axial stop; and
the seal shroud includes a shroud lip;
wherein the shroud lip is disposed axially between the axial stop and the retaining wire.

16. The face seal assembly of claim 9, further comprising a biasing element disposed at the seal carrier configured to urge the seal element toward a sealing surface.

17. A method of assembling two components comprising:
positioning a first component radially inboard of a second component, the second component including one or more flange segments circumferentially spaced apart by one or more flange openings, each flange segment including a groove extending radially outwardly from a radially inboard surface of each flange segment between the first component and the second component;
inserting a first end of a retaining wire into the groove via a first flange opening of the one or more flange openings;
urging the retaining wire through the groove of each flange segment until a second end of the retaining wire is located at the first flange opening; and
retaining the first component to the second component via the retaining wire installed in the groove.

18. The method of claim 17, further comprising inserting the second end into the groove at a flange segment at an opposite end of the first flange opening at which the first end was inserted.

19. The method of claim 17, further comprising forming a removal feature in a second wire end of the retaining wire.

20. The method of claim 19, further comprising removing the retaining wire by pulling the removal feature.
